(19) United States
(12) Patent Application Publication
(10) Pub. No.: US 2021/0008652 A1
(43) Pub. Date: Jan. 14, 2021

(54) METHOD FOR MACHINING A VARIABLE-PITCH TOOTHING ON A STEERING RACK

(71) Applicant: JTEKT EUROPE, Irigny (FR)

(72) Inventors: Pascal VIZIER, St Genis Laval (FR); Jean-Michel SANIEZ, Aulnoy lez Valenciennes (FR); Benoit CAMPALTO, Lyon (FR); Emeric RICHARD-VITTON, Lyon (FR); Jean-Christophe ORSET, Massieux (FR); Alain ISSARTEL, Doizieux (FR)

(73) Assignee: JTEKT EUROPE, Irigny (FR)

(21) Appl. No.: 16/980,707

(22) PCT Filed: Mar. 8, 2019
(86) PCT No.: PCT/FR2019/050519

§ 371 Date: Sep. 14, 2020

(30) Foreign Application Priority Data
Mar. 12, 2018 (FR) 18/52104

(51) Int. Cl. B23F 1/06; B23C 3/34

(52) U.S. Cl. CPC B23F 1/06; B23C 3/34

(57) ABSTRACT

A method for machining a toothing with variable pitch on a rack implemented by a machine tool other than a ball nose milling cutter and includes at least five axes allowing positioning the cutting tool relative to the rack, namely a first, a second and a third axis of translation, forming a three dimension space, a first axis of rotation allowing modifying a yaw position, about a yaw axis parallel to the first axis of translation, and a second axis of rotation allowing orienting a roll position about the second axis of translation, and includes at least one cutting phase during which the cutting tool is controlled in «five continuous axes», by simultaneously modifying, during the same iteration, the spatial control component of each of the five axes, whereas the cutting tool rotates and is applied in contact with the surface of the tooth which is being trimmed.

The present invention concerns the methods for manufacturing racks, that is to say toothed bars, which are intended, for example, for the steering mechanisms used in vehicles.

In some applications, it is useful to have a variable-pitch rack, that is to say whose toothing have a pitch (distance between two successive teeth) which is not constant. The rack comprises, on the one hand, a toothing formed of teeth and, on the other hand, a back of toothing opposite to the toothing. Furthermore, a tooth comprises a first flank and a second flank, generally symmetrical to the first flank, and a vertex connecting the first flank to the second flank.

Such a variable pitch indeed allows conferring a variable gear ratio between the rack and a pinion which meshes therewith.

Thus, for example, by using a smaller pitch, that is to say teeth closer together, in the middle of the rack than at the ends of said rack, a progressiveness of the steering control is obtained, which is more accurate in the vicinity of the straight line, for small displacements of the steering wheel, and faster during large displacements of the steering wheel, when turning or parking maneuvers.

In order to manufacture such racks, a forging method is known in particular, during which the bar to be formed is vertically compressed between two main punches, including a lower punch forming a cradle which bears against the back of the bar, and an toothed upper punch which forms the teeth on the opposite face of the bar.

During this method, the action of the two vertical punches is necessarily supplemented by the simultaneous action of two lateral punches, which push back and raise the material of the bar against the toothed upper punch. This method allows ensuring the filling of the toothed upper punch.

If such a manufacture by forging gives generally satisfactory results overall, it nevertheless includes some drawbacks.

First of all, the method is relatively imprecise, so that the dimensional tolerances of the teeth can reach several tenths of millimeters, which is hardly compatible with an accurate and smooth meshing.

This method is very dispersive on the location along a longitudinal axis of the rack of the back of toothing relative to the toothing +/−0.3 mm whereas in machining +/−0.06 mm can be easily reached) which can generate guide issues.

Depending on the concave/convex shape of some tooth flanks, linked to a quick gear change, some designs cannot be obtained by forging.

In addition, the lateral punches tend to modify the section of the bar, and in particular to narrow said section, which makes said bar more sensitive to bending.

Furthermore, forging requires heating the rack, which causes annealing the material responsible for a decrease in the mechanical strength limit of said rack.

Moreover, the forging does not allow making deep teeth, the maximum height of the teeth likely to be reached by this method being in practice limited to about 3.5 mm.

Moreover, the forging method leads to a connection of the surfaces of the tooth therebetween by curves instead of sharp edges, which reduces the contact surface of the rack with the pinion and contributes to the increase in contact pressures.

Finally, the forging requires bulky and very expensive tooling, which reserves this method for mass production, and does not allow changing the specifications of the rack.

Conversely, it is also known, for unit production of special racks, to resort to machining by a cutting tool consisting of a milling ball cutter.

Such machining methods allow reaching a much greater dimensional accuracy, with tolerances well below a tenth of a millimeter.

However, the use of such a method of trimming by milling ball cutter considerably increases the manufacturing time («cycle time»), which can thus reach several hours (from 2 h to 4 h per rack depending on the number of teeth and the concave or convex shape of each flank).

Consequently, the machining with a milling ball cutter type cutting tool is unsuitable for mass production of variable-pitch racks.

The objects assigned to the invention therefore aim at overcoming the aforementioned drawbacks and at proposing a new method for manufacturing variable-pitch toothed racks which allows a quick and accurate manufacture and which is inexpensive to implement.

The objects assigned to the invention are achieved by means of a method for machining a variable-pitch toothing on a rack, said method being characterized in that it is implemented by a machine tool which is provided with a rotary cutting tool other than a milling ball cutter and which comprises at least five axes allowing positioning said cutting tool relative to the rack, namely a first axis of translation, a second axis of translation and a third axis of translation, forming a three dimension space, a first axis of rotation allowing modifying a yaw position, about a yaw axis parallel to the first axis of translation, and a second axis of rotation allowing orienting a roll position about the second axis of translation, and in that said method comprises at least one cutting phase during which the tool is controlled in «five continuous axes», by simultaneously modifying, during the same iteration, the spatial control component of each of said five axes, while the cutting tool rotates and is applied in contact with the surface of the tooth which is being trimmed.

A yaw movement of an object is a horizontal rotational movement of the object about a vertical axis. The yaw movement corresponds to the succession of the yaw positions of the object.

A roll movement of an object is a rotational movement of the object about the longitudinal axis thereof.

Advantageously, the inventors have indeed discovered that continuous control on five axes, that is to say by refreshing and by adapting to each iteration, during several successive iterations, the position of the cutting tool according to each of the five aforementioned and judiciously chosen axes made it possible to follow at any time the profile of the surface of the tooth flank during trimming, and this including with a non-spherical cutting tool, and in particular with a cylindrical cutting tool, such as a disk milling cutter, which has a material removal capacity much greater than the capacity of a spherical milling ball cutter.

Thus, the use of a suitably configured five-axis machine makes it possible to use a cutting tool other than a milling ball cutter, and in particular a cutting tool which is more efficient and exhibits a much higher efficiency in terms of amount of material removed per time unit.

Thus, the invention advantageously allows combining the high precision of the machining with a very short cycle time per tooth, comprised between 2 and 10 minutes depending on the curvature of the tooth flanks, that is to say the profile of the surface of the tooth flank.

The method according to the invention thus allows gaining time and accuracy.

Finally, the invention has a great versatility, to the extent that it allows, if necessary, to quickly change the manufacture range (dimensions of the rack, number of teetingh, tooth profile, etc.) by changing the machining program of the machine tool, from a toothing definition calculation file which defines the desired rack, without it being necessary to manufacture a new tooling.

Depending on the profile of the surface of the tooth flank, it may be necessary to successively use cutting tools of different shapes depending on the pitch of the teeth. These cutting tools can be changed quickly when they are positioned in a magazine of the machine tool beforehand.

Other objects, features and advantages of the invention will appear in more detail on reading the following description, as well as using the appended drawings, provided for purely illustrative and non-limiting purposes, among which

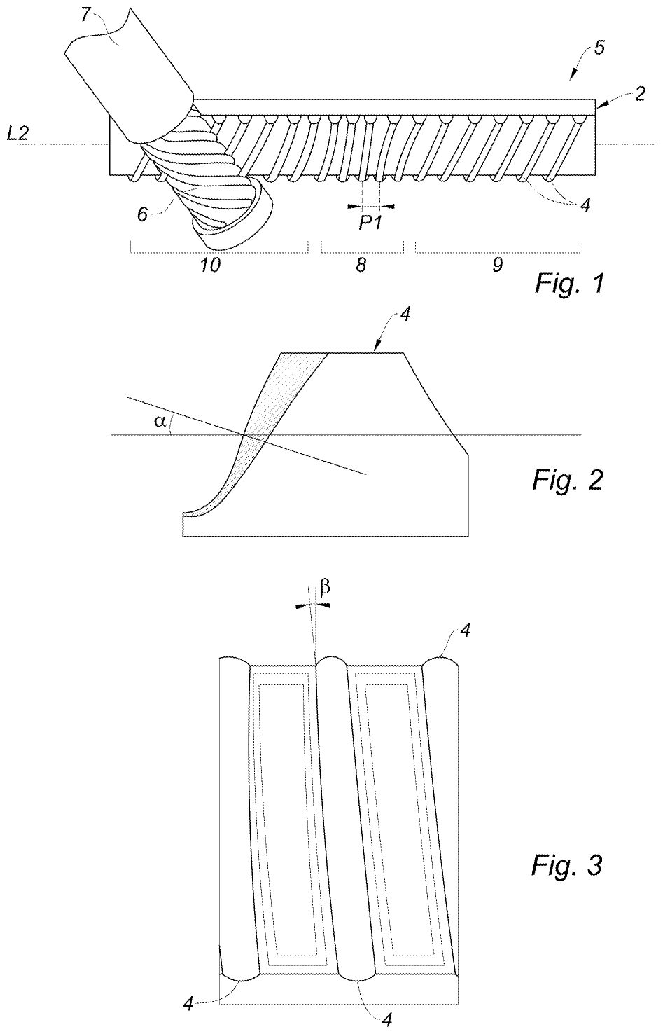

FIG. 1 illustrates, in a schematic perspective view, a portion of a steering mechanism for a vehicle comprising a pinion which meshes with a variable-pitch toothed rack manufactured according to the method of the invention.

FIG. 2 illustrates, in a partial sectional view in a normal plane of the variable-pitch toothing, a tooth section showing the pressure angle.

FIG. 3 illustrates, in a partial view in projection from above, a tooth of the variable-pitch toothing, showing the helix angle.

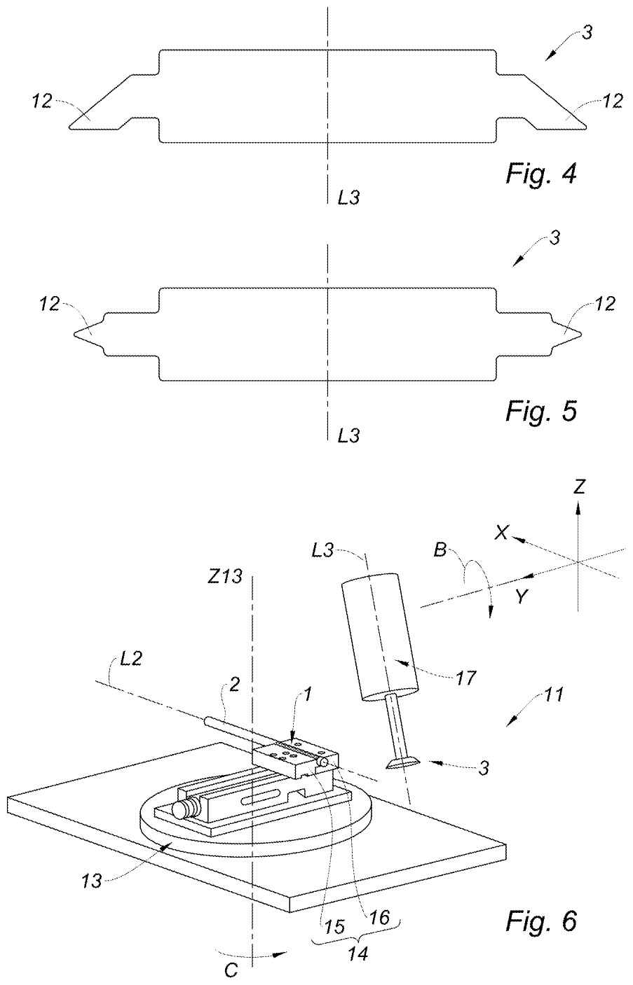

FIG. 4 illustrates an example of a disk milling cutter according to a first embodiment likely of being used as a cutting tool in the method according to the invention.

FIG. 5 illustrates an example of a disk milling cutter according to a second embodiment which can be used as a cutting tool in the method according to the invention.

FIG. 6 illustrates, in a schematic perspective view, an example of a five-axis machine tool arrangement according to the invention.

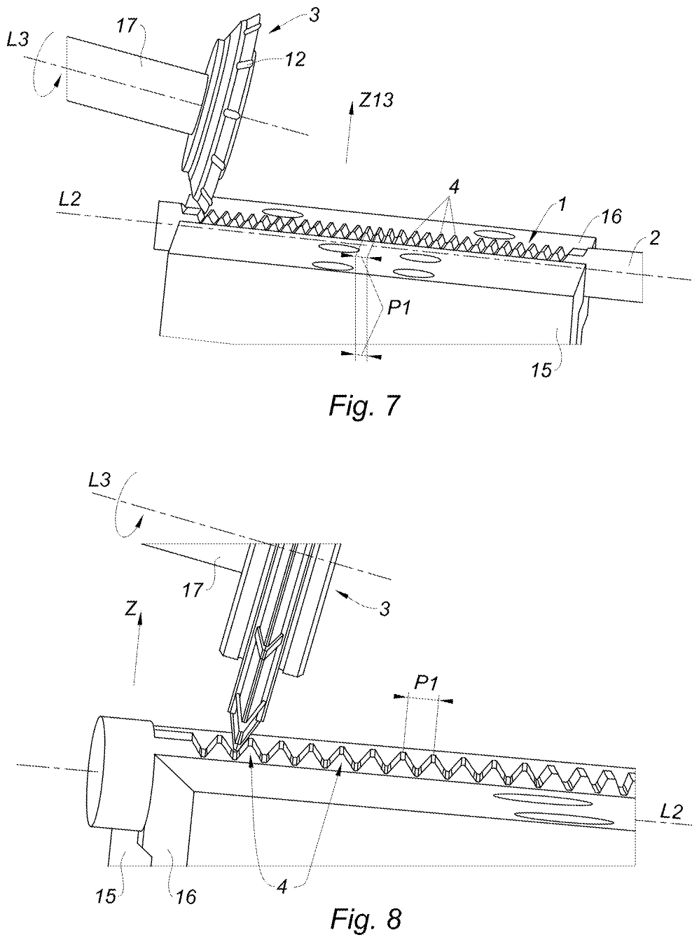

FIG. 7 illustrates, in a detail view, the machining of a variable-pitch toothing by means of the disk milling cutter according to the first embodiment, according to a method in accordance with the invention.

FIG. 8 illustrates, in a detail view, the machining of a variable-pitch toothing by means of the disk milling cutter according to the second embodiment, according to a method in accordance with the invention.

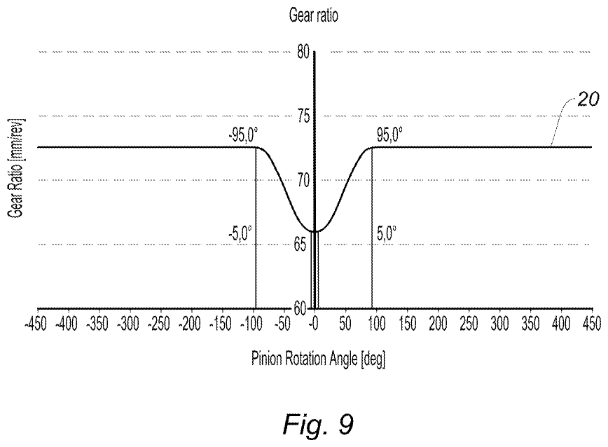

FIG. 9 illustrates a gear ratio of the variable-pitch rack depending on a rotation of the pinion.

The invention concerns a method for machining a variable-pitch toothing 1 on a rack 2.

The term «machining method» means a method for removing material by cutting chips by means of a movable cutting tool 3, preferably a rotary cutting tool 3 such as a milling cutter, which is driven in rotation about of its own central axis L3 to obtain the cutting effect.

The rack 2 is made by cutting a toothing 1 in a rectilinear bar, preferably a metal bar, for mechanical strength issues when using said rack.

The toothing 1 has a variable pitch P1, that is to say that the interval P1 which axially separates two successive teeth 4 varies according to the position and the curvature of said teeth 4 along the longitudinal axis L2 of the rack 2.

This allows in particular varying the gear ratio depending on the considered meshing area.

Thus, in the example of a steering mechanism 5 for a vehicle, such as that illustrated in FIG. 1, within which the rack 2 meshes with a pinion 6, itself driven for example by an assist motor and/or by a steering column 7 connected to a steering wheel, a short pitch P1 can be provided in the middle area 8 of the rack 2, so as to obtain greater accuracy in the steering maneuvers in the vicinity of the straight line, then increase the pitch P1 when moving away from the middle area towards the end areas 9, 10 of the rack, so as to accelerate large-scale movements, in particular during parking maneuvers. The difference in behavior of the steering movements in the middle area 8 and the end areas 9, 10 is represented by the curve 20 of FIG. 9 which illustrates a gear ratio of the variable-pitch rack 2 depending on a rotation (Pinion Rotation Angle) of the pinion 6. For a Pinion Rotation Angle 6 close to 0°, that is to say in the middle area 8, the gear ratio is substantially constant in order to promote the driving accuracy and the steering wheel feeling in a straight line. While for angles of rotation of the pinion 6 comprised substantially between 20° and 100° and −20° and −100°, that is to say in the end areas 9, 10, the gear ratio increases sharply thus allowing promoting the trajectory of the vehicle.

According to the invention, the method is implemented by a machine tool 11 which is provided with a rotary cutting tool 3, other than a milling ball cutter.

Advantageously, this type of cutting tool 3, which is non-spherical, and more particularly forming a disc about the central axis L3, allows obtaining a higher efficiency than that of a milling ball cutter, in terms of amount of material removed per tool revolution, and therefore per time unit.

Generally, the metal-removal rate is calculated using the following formula:

Q=(Ap ×Ae×Vf)/1000.

Where Ap is an axial depth of one pass in mm, Ae is a radial depth of one pass in mm and Vf is the tool feed speed in mm/min.

Thus, the following results are obtained under the current cutting conditions:
Disc: Q=14.73 cm³/min
Ball Ø6: Q=0.84 cm³/min
Ball Ø4: Q=0.273 cm³/min
Ball Ø2: Q=0.049 cm³/min

Preferably, the cutting tool 3 is formed by a disk milling cutter, such as that represented in FIG. 7, or FIG. 8, or in section in FIGS. 4 and 5.

A disk milling cutter is in the form of a circular disc, wider radially than thick axially (vis-à-vis the central axis L3), and whose perimeter is lined with cutting teeth 12, commonly called inserts.

According to the invention, and as illustrated in FIG. 6, the machine tool 11 comprises at least five axes X, Y, Z, B, C, or even exactly five axes, which allows positioning the cutting tool 3 relative to the rack 2, namely a first axis of translation Z, a second axis of translation Y, perpendicular to the first axis of translation Z, and a third axis of translation X, perpendicular to the two previous axes, such that the three axes of translation X, Y, Z form a three dimension space, as well as a first axis of rotation C allowing modifying a yaw position, about a yaw axis Z13 parallel to the first axis of translation Z, and a second axis of rotation B allowing orienting a roll position about the second axis of translation Y.

Preferably, the first translation axis Z is vertical relative to a turntable 13 on which the rack 2 is fastened, the other two axes Y, X being horizontal, that is to say parallel to the plane of the turntable 13.

These translation axes X, Y, Z are for example be materialized by rectilinear motorized translation tables, for example translation tables with ball screws or with linear bearing rails.

The three dimension space X, Y, Z advantageously defines the machine coordinate system associated with the frame of the machine tool 11.

According to a first embodiment, the first axis of rotation C allows modifying the yaw position of the cutting tool 3 relative to the rack 2 and the second axis of rotation B allows orienting the roll position of the rack.

According to a second embodiment, the first axis of rotation C allows modifying the yaw position of the rack 2 relative to the cutting tool 3 and the second axis of rotation B allows orienting the roll position of the cutting tool.

For clarity reasons in the remainder of the description, we will refer to the second embodiment.

Preferably, the position of the rack 2 about the first yaw axis of rotation C, Z13, also called the yaw orientation, will be made by means of a turntable 13 centered on the axis Z13 and mounted on the frame of the machine tool 11.

Preferably, the rack 2 will be fastened on said turntable 13 by means of a flange 14 with jaws 15, 16.

The roll orientation B is carried out by tilting the tool head 17 of the machine, and consequently the central axis L3 of the cutting tool 3, pivotally about the second axis of translation Y.

According to the invention, the method comprises at least one cutting phase during which the cutting tool 3 is controlled in «five continuous axes», by simultaneously modifying, during the same iteration, the spatial control component of each of said five axes X, Y, Z, B, C, while the cutting tool 3 rotates and is applied (continuously) in contact with the surface of the tooth 4 which is being trimmed.

The «continuous» operating consists in modifying during the same iteration, and therefore almost simultaneously, on the one hand, the position of the tool head 17, and therefore of the cutting tool 3, on each of the axes of translation X, Y, Z, thus actuating a specific translational displacement on each of the three motorized axes of translation X, Y, Z, and on the other hand, the yaw and roll orientation of the tool head 17, and therefore of the cutting tool 3, on each of the corresponding axes of rotation C, B, by actuating a specific rotational displacement on each of these two motorized yaw C and roll B axes of rotation.

Advantageously, the position setpoint, respectively the orientation setpoint, specific to each of the five axes X, Y, Z, B, C is thus refreshed and modified at each iteration, repeatedly during a plurality of successive iterations, and this so as to permanently reposition, and without jerking, the cutting tool 3, without it being necessary to interrupt the rotation of the cutting tool 3 on its central axis L3 or to remove the cutting tool 3 from the surface of the tooth 4 to be machined, and so as to properly orient the cutting edge of the cutting tool 3 depending on the vector normal to the surface to be machined, at the considered (spatial) point, at each considered moment.

This continuous five-axis control advantageously allows making possible the trimming of the left surfaces of the teeth 4 by a non-spherical cutting tool 3, with high efficiency, and which will always «stick» to the surface to be trimmed, on (in contact with) which said cutting tool 3 is displaced.

It should be noted that the five axes described above are sufficient for the implementation of the method.

This being the case, a machine tool 11 could be provided having more axes, and in particular six axes, given that, among these six axes, there are the five axes above, and that said five axes are actuated continuously.

Advantageously, the modification of the relative attitude of the cutting tool 3 relative to the rack 2, as permitted and monitored by the first yaw axis of rotation C and the second roll axis of rotation B, allows adapting the cutting operation, at any time, to the helix angle β (yaw C) to the pressure angle α (roll B) and which one wishes to impart to the flank of the tooth 4 at the considered instant and point.

Thus, according to a preferred feature which can constitute a full-fledged invention, regardless in particular of the type of used cutting tool 3, the tooth 4 during trimming has a helix angle β, and the control of the helix angle β of the tooth 4 during trimming is assigned to the first yaw axis of rotation C.

By adjusting and modifying in real time the spatial controlling component of the first yaw axis of rotation C, that is to say the yaw orientation setpoint, of the yaw axis of rotation C, herein of the turntable 13, the orientation setpoint is also modified along the axes X and Y. Thus, the spatial configuration of the cutting tool 3 is adapted to the desired helix angle β at the considered point of the surface of the tooth 4, at the considered moment.

Similarly, according to a preferred feature which may constitute a full-fledged invention, the control of the pressure angle α of the tooth 4 during trimming is assigned to the second roll axis of rotation B.

By adjusting and modifying in real time the spatial control component of the second roll axis of rotation B, that is to say the tilting orientation setpoint of the tool head 17, the orientation setpoint is also modified along the first yaw axis of rotation C and therefore the setpoint is also modified along the three axes of translation X, Y, Z. Thus, the spatial configuration of the cutting tool 3 is adapted to the desired pressure angle α at the considered point of the surface of the tooth 4, at the considered instant.

Particularly preferably, both the helix angle β is managed by means of the first yaw axis of rotation C, Z13 and, distinctly, the pressure angle α by means of the second roll axis of rotation B.

Preferably, the method includes a programming step during which a file for controlling the machine tool 11 is generated, by means of a computer, and a Computer Aided Manufacturing (CAM) software, which comprises: the coordinates (x, y, z) of a target point of the surface to be machined according to each of the first, second and third translation axes X, Y, Z, the setpoint for controlling the rack 2, herein more particularly the yaw orientation setpoint of the turntable 13, according to the first axis of rotation C, depending on the helix angle β desired for the surface to be trimmed, and the roll control instruction according to the second axis of rotation B, depending on the pressure angle α desired for the surface to be trimmed.

In another embodiment, the file for controlling the machine tool 11 also comprises the coordinates (Nx, Ny, Nz) of the vector normal to the surface to be machined at the considered point.

Thus, it will be possible to easily automate, by means of a control file having a simple and relatively compact structure, the production of the rack 2, as well as the possible changes in production range (by simply recompiling, at each change of range , a new controlling file from the corresponding new CAD data).

Moreover, the invention will concern as such the use of a machine tool 11 with five continuous axes X, Y, Z, B, C provided with a rotary cutting tool 3 other than a milling ball cutter for machining a toothing 1 with variable pitch P1 on a rack 2, and more particularly on a steering rack 2.

The invention also concerns an assisted steering system provided with a rack 2 obtained according to the method of the invention, as well as a vehicle equipped with such a power steering system.

Of course, the invention is in no way limited to the sole variants described above, those skilled in the art being in particular in position to isolate or freely combine together the aforementioned features, or to substitute them with an equivalent.

1. A method for machining a toothing with variable pitch on a rack, said method being implemented by a machine tool which is provided with a rotary cutting tool other than a milling ball cutter and which comprises at least five axes allowing positioning said cutting tool relative to the rack, namely a first axis of translation, a second axis of translation and a third axis of translation, forming a three dimension space, a first axis of rotation allowing modifying a yaw position, about a yaw axis parallel to the first axis of translation, and a second axis of rotation allowing orienting a roll position about the second axis of translation, and in that said method comprises at least one cutting phase during which the cutting tool is controlled in «five continuous axes» by simultaneously modifying, during the same iteration, the spatial control component of each of said five axes, whereas the cutting tool rotates and is applied in contact with the surface of the tooth which is being trimmed.

2. The method according to claim 1 wherein the first axis of rotation allows modifying the yaw position of the cutting tool relative to the rack and the second axis of rotation allows orienting the roll position of the rack.

3. The method according to claim 1 wherein the first axis of rotation allows modifying the yaw position of the rack relative to the cutting tool and the second axis of rotation allows orienting the roll position of the cutting tool.

4. The method according to claim 1, wherein the tooth during trimming has a helix angle, and in that the control of the helix angle of the tooth during trimming is assigned to the first yaw axis of rotation.

5. The method according to claim 1, wherein the control of the pressure angle of the tooth during trimming is assigned to the second roll axis of rotation.

6. The method according to claim 1, wherein it includes a programming step during which, a file for controlling the machine tool is generated, by means of a computer and a software, which comprises: the coordinates of a target point of the surface to be machined along each of the first, second and third axes of translation, the yaw control setpoint of the rack along to the first axis of rotation, depending on the desired helix angle for the surface to be trimmed, and the roll control setpoint along the second axis of rotation, depending on the desired pressure angle for the surface to be trimmed.

7. The method according to claim 6, wherein the machine tool control file also comprises the coordinates of the vector normal to the surface to be machined at the considered point.

8. The method according to claim 1, wherein the cutting tool is formed by a disk milling cutter.

9. A power steering system provided with a rack having a toothing with variable pitch machined according to a method in accordance with claim 1.
